(19) United States
(12) Patent Application Publication
(10) Pub. No.: US 2022/0395856 A1
(43) Pub. Date: Dec. 15, 2022

(54) POWDER COATING DEVICE AND POWDER COATING METHOD

(71) Applicant: HONDA MOTOR CO., LTD., Tokyo (JP)

(72) Inventors: Hiroaki MATSUMOTO, Tokyo (JP); Yosuke SUZUKI, Tokyo (JP); Muneki YAMADA, Tokyo (JP); Naoki YAMAMOTO, Tokyo (JP); Kenji MASAI, Tokyo (JP)

(21) Appl. No.: 17/661,918

(22) Filed: May 4, 2022

(30) Foreign Application Priority Data
Jun. 11, 2021 (JP) 2021-097858

(51) Int. Cl. B05C 19/02; B05C 19/06; B05C 19/00; B05C 13/00

(52) U.S. Cl. CPC B05C 19/02; B05C 19/06; B05C 19/008; B05C 13/00

(57) ABSTRACT

A powder coating device includes a powder fluidizing tank configured to store resin powder, a workpiece gripper configured to grip a stator W, and a workpiece conveyor configured to convey the workpiece gripper to immerse at least a part of the stator W gripped by the workpiece gripper into the resin powder in the powder fluidizing tank. The workpiece gripper includes a vibrator configured to apply vibrations to the stator.

This application is based on and claims the benefit of priority from Japanese Patent Application No. 2021-097858, filed on 11 Jun. 2021, the content of which is incorporated herein by reference.

### BACKGROUND OF THE INVENTION

### Field of the Invention

The present invention relates to a powder coating device and a powder coating method.

### Related Art

Conventionally, a fluidized bed coating process has been used when insulating powder is applied onto a workpiece such as coil ends of a stator serving as one part of a motor to be mounted in a vehicle. Japanese Patent No. 6596477 describes a powder coating device including a powder fluidizing tank including a first partition plate and a second partition plate serving as porous plates and a vibrator coupled to a bottom surface of the powder fluidizing tank.
Patent Document 1: Japanese Patent. No. 6596477

### SUMMARY OF THE INVENTION

By the way, in such a device as described in Japanese Patent No. 6596477, air is allowed to flow via porous plates, and a powder fluidizing tank is caused to vibrate to fluidize resin powder in the powder fluidizing tank to apply the resin powder onto a workpiece. However, in this method, since vibration functions are concentrated locally on and around the powder fluidizing tank to vibrate the powder resin in the powder fluidizing tank that is away from the workpiece, it has been difficult to replicate optimum vibration conditions. Therefore, there is a need for improvements in terms of more even application of coating onto the workpiece.

An object of the present invention is to provide a powder coating device and a powder coating method, which make it possible to more evenly apply coating onto a workpiece.

An aspect of the present invention relates to a powder coating device including a powder fluidizing tank configured to store resin powder, a workpiece gripper configured to grip a workpiece, and a workpiece conveyor configured to convey the workpiece gripper to immerse at least a part of the workpiece gripped by the workpiece gripper into the resin powder in the powder fluidizing tank. The workpiece gripper includes a vibrator configured to apply vibrations to the workpiece.

The workpiece conveyor may be able to move the workpiece gripper upward and downward, in a state where at least the part of the workpiece gripped by the workpiece gripper is immersed into the resin powder in the powder fluidizing tank.

Another aspect of the present invention relates to a powder coating method for applying a resin powder onto a workpiece by using a powder coating device including a powder fluidizing tank configured to store resin powder, a workpiece gripper configured to grip the workpiece, and a workpiece conveyor configured to convey the workpiece gripper, the powder coating method including, in a state where at least a part of the workpiece gripped by the workpiece gripper is immersed into the resin powder in the powder fluidizing tank, applying the resin powder while vibrations are applied from the workpiece gripper to the workpiece.

In a state where at least the part of the workpiece gripped by the workpiece gripper is immersed into the resin powder in the powder fluidizing tank, the resin powder may be applied while the workpiece conveyor is moved upward and downward by the workpiece gripper.

According to the present invention, it is possible to provide a powder coating device and a powder coating method, which make it possible to more evenly apply coating onto a workpiece.

### BRIEF DESCRIPTION OF THE DRAWINGS

FIG. 1 is a schematic view illustrating a powder coating device according to an embodiment of the present invention;

FIG. 2 is a perspective view illustrating a stator;

FIG. 3 is an exploded perspective view illustrating a stator core and a coil;

FIG. 4 is a perspective view illustrating a conductor segment group to be inserted into slots of the stator core in the stator;

FIG. 5 is a perspective view illustrating in an enlarged manner coil ends before insulating powder is applied;

FIG. 6 is a perspective view illustrating in an enlarged manner the coil ends after the insulating powder is applied;

FIG. 7 is a cross-sectional view illustrating a powder fluidizing tank and a workpiece gripper of the powder coating device according to the embodiment of the present invention;

FIG. 8 is a view when the stator gripped by the workpiece gripper illustrated in FIG. 7 is seen from the powder fluidizing tank; and

FIG. 9 is a view illustrating a flowchart of a powder coating method according to the embodiment of the present invention.

### DETAILED DESCRIPTION OF THE INVENTION

An embodiment of the present invention will now be described herein in detail with reference to the accompanying drawings.

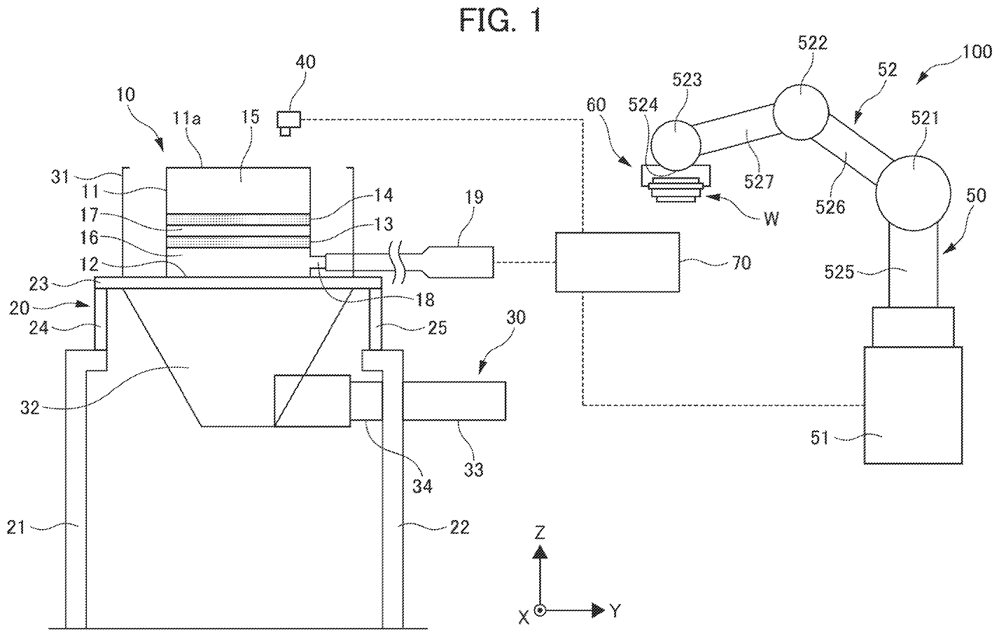

A powder coating device 1 according to the present embodiment will now be described herein with reference to FIG. 1. FIG. 1 is a schematic view illustrating the powder coating device 1. Note that, in an orthogonal coordinate system XYZ illustrated in the drawings, a direction parallel to a horizontal plane is referred to as an X-axis direction, a direction in the horizontal plane, which is orthogonal to the X-axis direction, is referred to as a Y-axis direction, and a vertical direction is referred to as a Z-axis direction.

The powder coating device 1 represents a device configured to apply resin powder onto a workpiece through a fluidized bed coating process. As illustrated in FIG. 1, the powder coating device 1 includes a powder fluidizing tank 10, a base 20 supporting the powder fluidizing tank 10 on an installation surface, a dust collecting mechanism 30, a level meter 40 configured to detect a height of a powder surface in the powder fluidizing tank 10, an articulated robot 100, and a controller 70.

Below describes a case where a stator W serving as a part of a motor to be mounted in a vehicle is used as a workpiece, and insulating powder is used as resin powder. However, the workpiece and the resin powder are not particularly limited. One example resin constituting the insulating powder is an epoxy resin.

The powder fluidizing tank 10 has a substantially circular shape, when viewed from above. The powder fluidizing tank 10 includes a body 11 having a cylindrical shape, a bottom plate 12 having a substantially disc shape, a first partition plate 13 having a substantially disc shape, and a second partition plate 14 having a substantially disc shape. The first partition plate 13 and the second partition plate 14 are provided inside the body 11. The first partition plate 13 and the second partition plate 14 respectively are porous plates formed with small holes each having a bore diameter that is smaller than a grain diameter of the insulating powder.

A powder storage 15 storing the insulating powder is partitioned by an edge 11a of the body 11 and the second partition plate 14. Furthermore, a first air chamber 16 is partitioned by the bottom plate 12 and the first partition plate 13. A second air chamber 17 is partitioned by the first partition plate 13 and the second partition plate 14. Furthermore, the first air chamber 16 is supplied with air at a predetermined speed from an air supply 19 via an air supply port 18. The air supplied to the first air chamber 16 flows, via the first partition plate 13, into the second air chamber 17, and then flows, via the second partition plate 14, into the powder storage 15. As a result, the insulating powder stored in the powder storage 15 is fluidized.

The base 20 includes fixing frames 21, 22, a fixing plate 23, and coupling members 24, 25 coupling the fixing frames 21, 22 and the fixing plate 23 to each other.

The fixing frames 21, 22 extend along the vertical direction. Respective ends on lower sides of the fixing frames 21, 22 are fixed to the installation surface.

The fixing plate 23 has a substantially disc shape, when viewed from above, and is provided in a substantially coaxial manner to a central axis of the powder fluidizing tank 10. The fixing plate 23 extends along horizontal direction. The powder fluidizing tank 10 is disposed on an upper surface of the fixing plate 23. A diameter of the fixing plate 23 is larger than a diameter of the bottom plate 12 of the powder fluidizing tank 10. Furthermore, a plurality of through holes are formed on the upper surface of the fixing plate 23.

The coupling member 24 has a shaft shape having an upper end fixed to a bottom surface of the fixing plate 23 and a lower end fixed to an upper end of the fixing frame 21. The coupling member 25 has a shaft shape having an upper end fixed to the bottom surface of the fixing plate 23 and a lower end fixed to an upper end of the fixing frame 22.

The dust collecting mechanism 30 includes a dust proof wall 31, a dust collecting hopper 32, and a dust collector 33. The dust proof wall 31 represents a wall extending upward from the upper surface of the fixing plate 23 to surround externally the powder fluidizing tank 10. The dust collecting hopper 32 has an upper end fixed to the bottom surface of the fixing plate 23. In the dust collecting hopper 32, the insulating powder that has flowed from the powder fluidizing tank 10 and that is present between the powder fluidizing tank 10 and the dust proof wall 31 is collected. The insulating powder collected in the dust collecting hopper 32 is trapped into the dust collector 33 via a dust collecting pipe 34.

The level meter 40 is provided above the powder fluidizing tank 10. The level meter 40 is configured to detect the height of the powder surface in the powder fluidizing tank 10 based on a triangulation ranging method, for example, and to send a signal corresponding to a detected value to the controller 70. Note herein that the height of the powder surface represents a distance from a predetermined reference (e.g., the edge 11a of the body 11). At this time, a light source is allowed to emit laser light toward a measurement position. Based on a position at which the laser light reflected by the powder surface forms an image on a light receiving element, the level meter 40 measures the height of the powder surface.

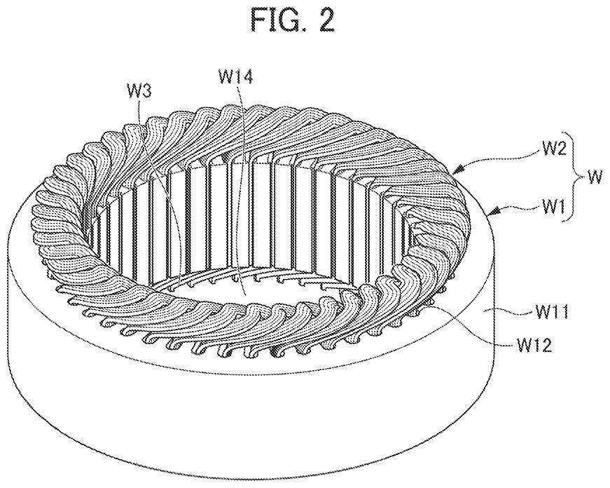

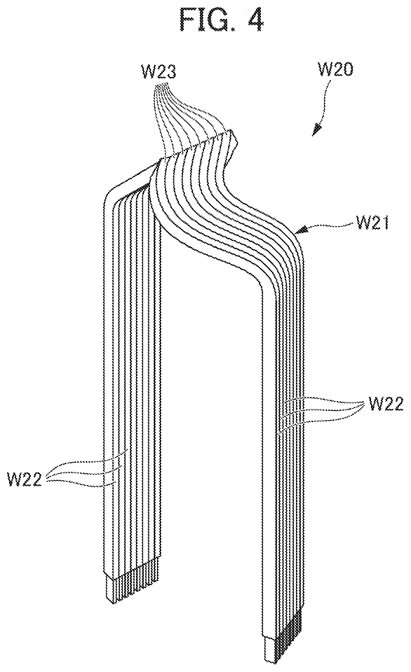

The articulated robot 100 represents a device that includes a workpiece conveyor 50 and a workpiece gripper 60 and that is able to grip and convey the stator W serving as a workpiece. Before describing the articulated robot 100, a detailed configuration of the stator W will now be described herein with reference to FIGS. 2 to 6.

The stator W represents a stator of a rotating electrical machine, for example, and includes a stator core W1 and coils W2 attached to the stator core W1. Lower ends of the coils W2 represent coil ends W3 onto which the insulating powder is to be applied.

The stator core W1 has, for example, an annular part W11 that is a laminated body in which a plurality of thin core plates are laminated with each other. The annular part W11 has a through hole W14 passing in an axial direction through its center and a plurality of slots W12 passing through in the axial direction. The slots W12 are arranged radially at constant intervals in a circumferential direction of the annular part W11, and respectively have openings W13 that open toward an inner circumference side of the annular part W11. The stator core W1 according to the present embodiment has the 48 slots W12. However, the number of the slots W12 is not limited to this number.

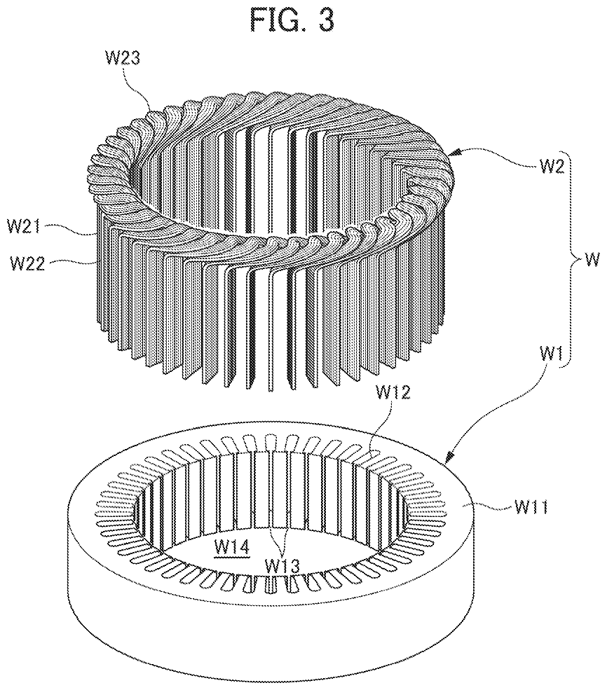

The coils W2 represent, for example, a plurality of conductor segment groups W20 each formed by laminating a plurality of conductor segments W21 each formed from a substantially U-shaped electric conductor made from a rectangular wire having a rectangular shape in cross section. The plurality of conductor segments W21 bundled are inserted, as illustrated in FIG. 3, into the slots W12 in the axial direction of the stator core W1. The conductor segments W21 inserted into the slots W12 are welded to each other by bending ends protruding outwardly in the axial direction of the stator core W1 from a side opposite to the side of the insertion, and then laser-welding the bent ends to each other.

Specifically, the conductor segments W21 before being inserted into the slots W12 of the stator core W1 each have a pair of parallel straight parts W22, W22 and a U-shaped part W23 coupling one ends of the straight parts W22, W22 to each other. The conductor segments W21 are attached, as illustrated in FIG. 2, to the stator core W1 by inserting the pair of straight parts W22, W22 respectively into the slots W12, W12 different from each other. In each one of the slots W12, the straight parts W22 of the plurality of conductor segments W21, which are laminated to each other in the radial direction of the stator core W1, are inserted. The straight parts W22 of the conductor segments W21 belonging to phases different from each other are respectively disposed in the slots W12, W12 lying adjacent to each other in the circumferential direction of the stator core W1.

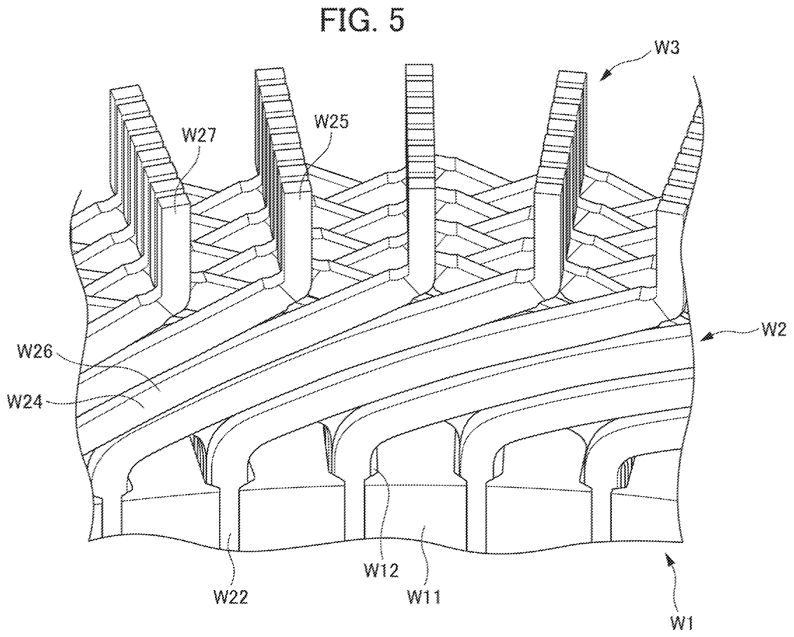

On the coils W2 after being inserted into the slots W12, as illustrated in FIG. 5, inclined parts W24 are formed by obliquely bending the ends, protruding from the slots W12, of the straight parts W22 in the circumferential direction, and raised parts W25 are also formed by bending tip sides of the inclined parts W24 upwardly in the axial direction of the stator core W1. That is, the inclined parts W24 and the raised parts W25 form the coil ends W3 of the coils W2.

Pairs of the inclined parts W24, W24 are bent from the slots W12 in a direction such that the pairs come closer to each other. Accordingly, pairs of the raised parts W25, W25 of the coils W2 are disposed in a laminated manner in the radial direction of the stator core W1. The coils W2 are therefore each formed into an annular shape. The plurality of coils W2 are coupled to each other by welding, such as by laser-welding, the raised parts W25, W25 of the coils W2 belonging to the same phase disposed in a laminated manner in the radial direction of the stator core W1. As described above, the plurality of inclined parts W24 and the plurality of raised parts W25 are disposed in a laminated manner in the radial direction of the stator core W1, allowing the coil ends W3 to form a complicated shape.

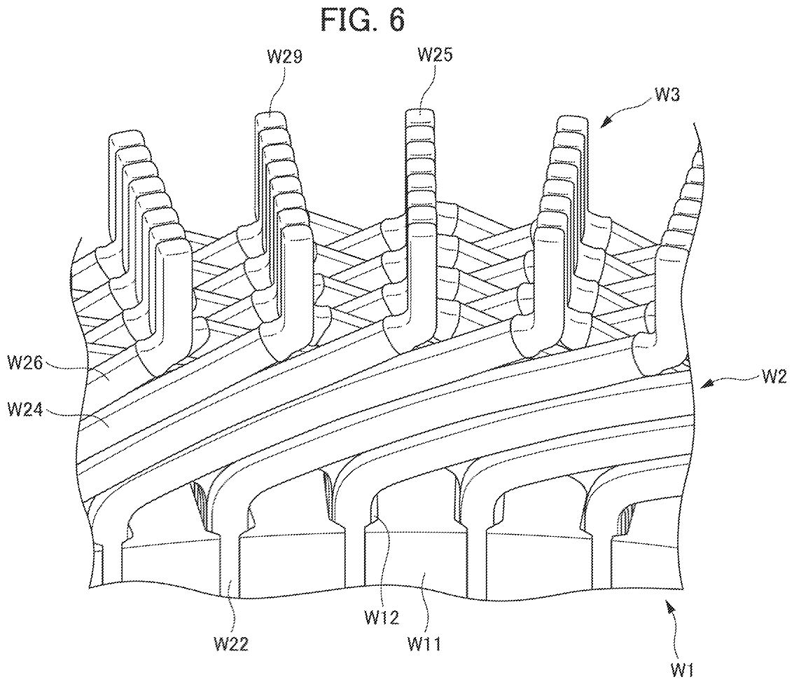

Insulation coating W26 is formed on the coils W2. Peeled-off parts W27 where the insulation coating W26 is peeled off are formed on the raised parts W25 of the coil ends W3. The insulating powder is to be applied onto the coil ends W3 forming the complicated shape to insulate the peeled-off parts W27. After the insulating powder is applied, as illustrated in FIG. 6, an insulating layer W29 is formed on the surface of each of the coil ends W3.

Next, a configuration of the articulated robot 100 will now be described herein. The articulated robot 100 includes, as illustrated in FIG. 1, the workpiece conveyor 50 and the workpiece gripper 60.

The workpiece conveyor 50 includes a stand 51 and an arm 52 turnably supported by the stand 51.

The arm 52 includes a first arm 525, a second arm 526, and a third arm 527, which are turnably supported by the stand 51, and further includes a first joint 521, a second joint 522, and a third joint 523, and a coupling member 524.

The first arm 525 is turnably supported by using, as a turning axis, an axis extending in a substantially vertical direction with respect to the stand 51.

The second arm 526 is coupled, via the first joint 521, to the first arm 525, and is supported to be able to change its angle with respect to the first arm 525 by using the first joint 521 as a fulcrum point.

The third arm 527 is coupled, via the second joint 522, to the second arm 526, and is supported to be able to change its angle with respect to the second arm 526 by using the second joint 522 as a fulcrum point.

The coupling member 524 is coupled, via the third joint 523, to the third arm 527. The coupling member 524 is turnably supported, on the third joint 523, by using, as a turning axis, an axis extending in a direction in which the third arm 527 extends. The workpiece gripper 60 is coupled, via the coupling member 524, to the arm 52. That is, the workpiece conveyor 50 is able to move the workpiece gripper 60 in the horizontal direction by turning the first arm 525 with respect to the stand 51, and is also able to move the workpiece gripper 60 in the vertical direction around the first joint 521 and the second joint 522. Furthermore, the workpiece conveyor 50 is able to invert the workpiece gripper 60 by using the third joint 523 as a fulcrum point.

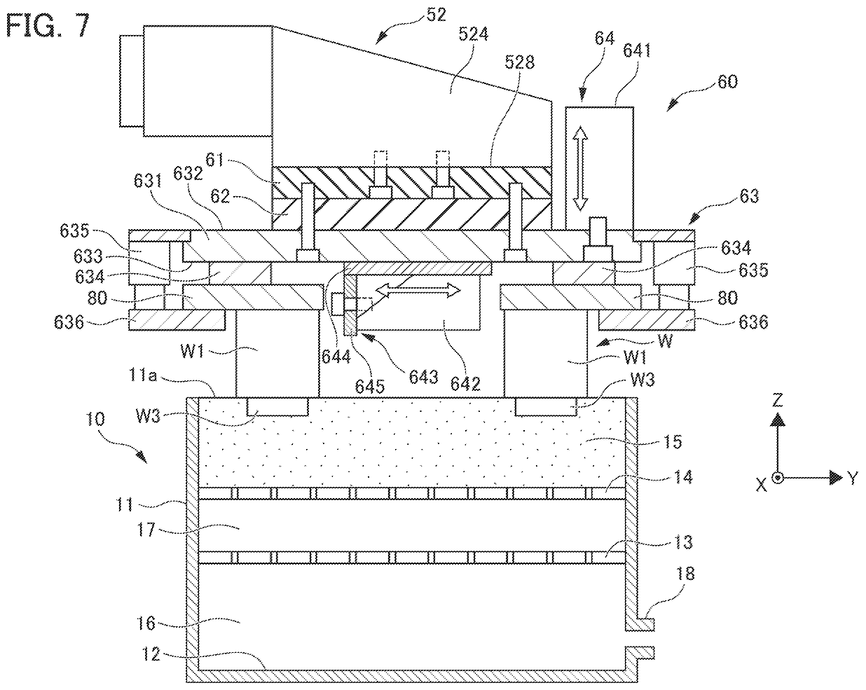

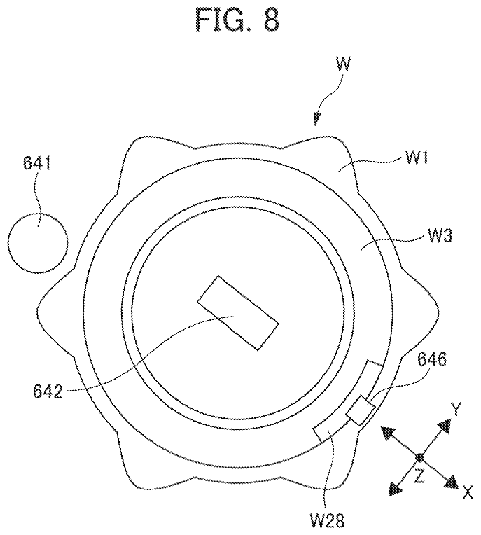

Next, the workpiece gripper 60 will now be described herein. FIG. 7 is a cross-sectional view illustrating the powder fluidizing tank 10 and the workpiece gripper 60 of the articulated robot 100, while coating is applied onto the coil ends W3. FIG. 8 is a view of the stator W gripped by the workpiece gripper 60 illustrated in FIG. 7, when seen from the powder fluidizing tank 10.

The workpiece gripper 60 is fixed to the coupling member 524 of the arm 52. The workpiece gripper 60 includes a workpiece pallet 80, a fixing panel 61, an elastic member 62, a clamp mechanism 63, and a vibrator 64. As illustrated in FIG. 7, in the present embodiment, in a state where the axial direction of the stator W gripped by the workpiece gripper 60 and the axial direction of the powder fluidizing tank 10 are substantially parallel to each other, the coil ends W3 are immersed into the powder storage 15 to apply coating.

The workpiece pallet 80 is formed into an annular shape, and is able to be coupled to ends lying opposite to each of the coil ends W3 of the stator W. The workpiece pallet 80 is gripped by the clamp mechanism 63.

The fixing panel 61 is fixed with screws to an end 528, which lies opposite to the third arm 527, of the coupling member 524. The elastic member 62 is attached to a surface lying opposite to the surface fixed to the end 528 on the fixing panel 61.

The elastic member 62 suppresses the transmission of vibrations to the workpiece conveyor 50. As the elastic member 62, a rubber member is used, for example. On the elastic member 62, the clamp mechanism 63 is attached to a surface lying opposite to the surface to which the fixing panel 61 is attached. As illustrated in FIG. 7, the fixing panel 61, the elastic member 62, and the clamp mechanism 63 are secured to each other with screws.

The clamp mechanism 63 is configured to be able to grip the workpiece pallet 80 to which the stator W is attached. The clamp mechanism 63 includes a clamp plate 631, claws 636, and clamp cylinders 635.

The clamp plate 631 has a substantially disc shape having a surface 632 on one side in its thickness direction, to which the elastic member 62 is fixed, and another surface 633 on another side in the thickness direction, on which a plurality of protrusion pieces 634 are formed. The protrusion pieces 634 are formed on a circumferential edge side of the clamp plate 631.

The claws 636 each have a plate shape, and are disposed to be both away at gaps from the protrusion pieces 634. The claws 636 are disposed at positions respectively overlapping partially with the protrusion pieces 634, when viewed from the powder fluidizing tank 10.

The clamp cylinders 635 each have an end side coupled to a circumferential edge of the clamp plate 631 and another end side coupled to each of the claws 636. The clamp mechanism 63 is able to grip the stator W by disposing the workpiece pallet 80 to which the stator W is attached between the protrusion pieces 634 and the claws 636, and by operating the clamp cylinders 635. The clamp mechanism 63 is able to grip the stator W in such a manner that the axial direction of the stator W and a central axis of the clamp plate 631 are substantially parallel to each other.

The vibrator 64 is configured to apply vibrations to the stator W gripped by the clamp mechanism 63. The vibrator 64 includes a first shaker 641, a second shaker 642, a bracket 643 fixing the second shaker 642, and a vibration meter 646.

The first shaker 641 is fixed with screws to the surface 632 on the circumferential edge side of the clamp plate 631. As indicated by a white hollow arrow in FIG. 7, the first shaker 641 is configured to be able to apply, to the stator W, vibrations in the axial direction of the stator W gripped by the clamp mechanism 63. That is, the first shaker 641 is able to apply, as illustrated in FIG. 7, vibrations in the vertical direction to the coil ends W3 immersed in the powder storage 15.

The second shaker 642 is fixed, via the bracket 643, to the other surface 633, around a center side, of the clamp plate 631. As indicated by a white hollow arrow in FIG. 7, the second shaker 642 is configured to be able to apply, to the stator W, vibrations in the radial direction of the stator W gripped by the clamp mechanism 63. That is, the second shaker 642 is able to apply, as illustrated in FIG. 7, vibrations in the horizontal direction to the coil ends W3 immersed in the powder storage 15.

The bracket 643 is wholly formed into an L shape in cross section. Specifically, the bracket 643 is fixed to the other surface 633 of the clamp plate 631, and has a first plate member 644 extending along the other surface 633 and a second plate member 645 extending, from an end on one side of the first plate member 644, in a direction substantially orthogonal to the clamp plate 631. In a state where the second shaker 642 is in contact with the first plate member 644 and the second plate member 645, the second shaker 642 is fixed with screws to the second plate member.

The vibration meter 646 is attached, as illustrated in FIG. 8, around three-phase lines W28 of the coil ends W3, and is configured to detect vibrations applied to the stator W, and to send a signal corresponding to a detected value to the controller 70.

The controller 70 includes, for example, a central processing unit (CPU), memories such as a read-only memory (ROM) and a random access memory (RAM), a microcomputer including input and output ports, and various circuits. The controller 70 is configured to follow predefined programs to control an air supply speed of the air supply 19, the driving of the workpiece conveyor 50 of the articulated robot 100, the driving of the clamp mechanism 63 of the workpiece gripper 60, and the driving of the vibrator 64. Specifically, for example, the controller 70 is able to control, in a state where the workpiece conveyor 50 is causing the coil ends W3 gripped by the workpiece gripper 60 to be immersed into the insulating powder in the powder fluidizing tank 10, the driving of the arm 52 and other components to move the workpiece gripper 60 upward and downward. Furthermore, the controller 70 is able to control the driving of the vibrator 64 to adjust the numbers of vibrations of the first shaker 641 and the second shaker 642.

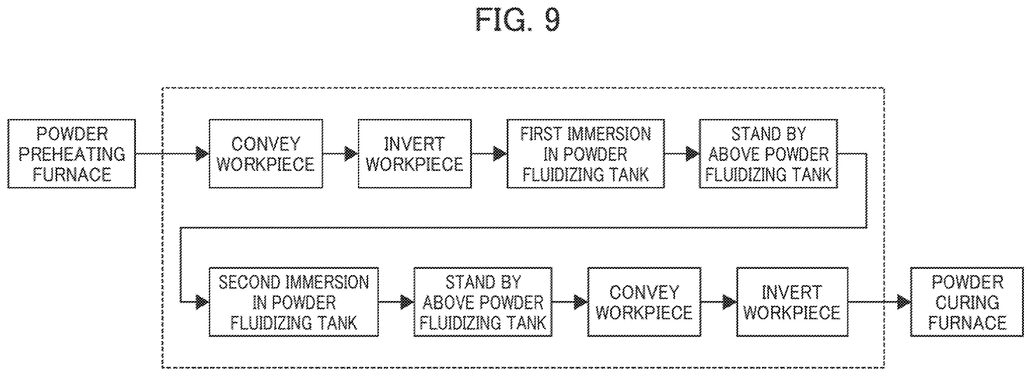

Next, the powder coating method according to the present embodiment will now be described herein with reference to FIG. 9. FIG. 9 is a flowchart illustrating the flow of the powder coating method.

The powder coating method according to the present embodiment includes a heating process of heating the stator W, a powder coating process of applying the insulating powder onto the coil ends W3 of the stator W, and a reheating process of heating again the stator W where the insulating powder is applied onto the coil ends W3.

In the heating process, the stator W is heated to a temperature allowing the insulating powder to be melted and applied onto the coil ends W3 in a powder preheating furnace.

In the powder coating process, the controller 70 drives the arm 52 and other components of the workpiece conveyor 50 to convey the stator W, which has been heated in the powder preheating furnace and which is gripped by the workpiece gripper 60, around a position above the powder fluidizing tank 10. At this time, the stator W is gripped by the workpiece gripper 60 with the coil ends W3 facing upward.

When the stator W is conveyed to a position above the powder fluidizing tank 10, the controller 70 controls the driving of the arm 52 to invert the workpiece gripper 60 by using the third joint 523 as a fulcrum point. As a result, the coil ends W3 of the stator W gripped by the workpiece gripper 60 face the powder surface in the powder storage 15 of the powder fluidizing tank 10.

After the stator W is inverted, the controller 70 controls the driving of the arm 52 to immerse the coil ends W3 of the stator W in the powder fluidizing tank 10. In a state where the coil ends W3 are immersed into the insulating powder in the powder fluidizing tank 10, the controller 70 causes the vibrator 64 to apply vibrations to the stator W, and controls the driving of the workpiece conveyor 50 to allow the workpiece conveyor 50 to move the workpiece gripper 60 upward and downward.

After a predetermined period of time has passed, the controller 70 controls the driving of the workpiece conveyor 50 to pull up the stator W from the powder storage 15 to a position above the powder fluidizing tank 10.

After the stator W has been pulled up to the position above the powder fluidizing tank 10, and a predetermined standby period of time has passed, the controller 70 controls the driving of the workpiece conveyor 50 to immerse again the coil ends W3 of the stator W in the powder fluidizing tank 10. In a state where the coil ends W3 are immersed into the insulating powder in the powder fluidizing tank 10, the controller 70 causes the vibrator 64 to apply vibrations to the stator W, and controls the driving of the workpiece gripper 60 and the workpiece conveyor 50 to allow the workpiece conveyor 50 to move the workpiece gripper 60 upward and downward.

After a predetermined period of time has passed, the controller 70 controls the driving of the workpiece conveyor 50 to pull up the stator W from the powder storage 15 to a position above the powder fluidizing tank 10.

After a predetermined period of time has passed, the controller 70 drives the arm 52 and other components of the workpiece conveyor 50 to convey the coil ends W3 to the powder curing furnace and to invert the stator W to allow the coil ends W3 to face upward.

In the reheating process, the controller 70 drives the arm 52 and other components of the workpiece conveyor 50 to convey the stator W into the powder curing furnace. The stator W where the melted insulating powder has been applied onto the coil ends W3 is heated again in the powder curing furnace. The insulating layer W29 is thus formed on each of the coil ends W3.

Note herein that, in a conventional powder coating device and a conventional powder coating method where air is allowed to flow via porous plates such as the first partition plate 13 and the second partition plate 14, and the powder fluidizing tank 10 is caused to vibrate to fluidize the resin powder in the powder fluidizing tank 10, the pores in the porous plates tend to be clogged due to the vibrations in the axial direction of the powder fluidizing tank 10. Particularly, when the powder fluidizing tank 10 moves conically, there are differences in vibrations in the axial direction between a central axis side and a circumferential edge side of each of the porous plates, increasing differences in clogging ratio of the pores in the porous plates between the central axis side and the circumferential edge side. As a result, in the powder fluidizing tank 10, radial flow occurs on the powder surface in the powder fluidizing tank 10, leading to reduced quality of powder coating.

In response to this, the powder coating device 1 according to the present embodiment includes the powder fluidizing tank 10 configured to store resin powder, the workpiece gripper 60 configured to grip the stator W, and the workpiece conveyor 50 configured to convey the workpiece gripper 60 to immerse at least a part of the stator W gripped by the workpiece gripper 60 into the insulating powder in the powder fluidizing tank 10. The workpiece gripper 60 includes the vibrator 64 configured to apply vibrations to the stator W. Therefore, it is possible to allow vibrations to occur between the stator W and the insulating powder without allowing the powder fluidizing tank 10 storing the insulating powder to vibrate. That is, instead of fluidizing the insulating powder in the powder fluidizing tank 10 by wholly shaking the tank, allowing a product to be immersed to vibrate makes it possible to fluidize the powder at an equivalent level when the powder fluidizing tank 10 is allowed to vibrate. Therefore, it is possible to suppress the occurrence of a radial flow on the powder surface due to the vibrations of the powder fluidizing tank 10, making it possible to apply more even coating onto application portions forming a complicated shape such as the coil ends W3. Furthermore, since vibrations are directly applied to the stator W, it is possible to easily set vibrations between the stator W and the insulating powder into an optimum state, making it possible to achieve high-quality powder coating. Furthermore, since it is possible to allow vibrations to occur in a space between the workpiece and the powder fluidizing tank without allowing the powder fluidizing tank to vibrate, it is possible to suppress deterioration of the porous plates caused by clogging of the pores due to the vibrations in the axial direction of the powder fluidizing tank, making it possible to extend the service life of the porous plates.

In the powder coating device 1 according to the present embodiment, the workpiece conveyor 50 is able to move the workpiece gripper 60 upward and downward in a state where at least a part of the stator W gripped by the workpiece gripper 60 is immersed into the insulating powder in the powder fluidizing tank 10. Therefore, since it is possible to allow the stator W immersed into the insulating powder in the powder fluidizing tank 10 to vibrate, and to move the immersed stator W upward and downward into the insulating powder, it is possible to allow the insulating powder to enter between the plurality of conductor segments W21 such as the coil ends W3 and to supply the insulating powder further inside the coil ends W3.

The powder coating method according to the present embodiment is a powder coating method for applying the insulating powder onto the stator W by using the powder coating device 1 including the powder fluidizing tank 10 configured to store resin powder, the workpiece gripper 60 configured to grip the stator W, and the workpiece conveyor 50 configured to convey the workpiece gripper 60. In a state where at least a part of the stator W gripped by the workpiece gripper 60 is immersed into the resin powder in the powder fluidizing tank 10, the resin powder is applied while vibrations are applied from the workpiece gripper 60 to the stator W. Therefore, since it is possible to allow vibrations to occur between the stator W and the insulating powder without allowing the powder fluidizing tank 10 storing the insulating powder to vibrate, it is possible to suppress the occurrence of a radial flow on the powder surface, making it possible to apply more even coating onto application portions formed into a complicated shape such as the coil ends W3. Furthermore, since vibrations are directly applied to the stator W, it is possible to easily set vibrations between the stator W and the insulating powder into an optimum state, making it possible to achieve high-quality powder coating. Furthermore, since it is possible to allow vibrations to occur in a space between the workpiece and the powder fluidizing tank without allowing the powder fluidizing tank to vibrate, it is possible to suppress the degradation of the porous plates through the clogging of the pores due to the vibrations in the axial direction of the powder fluidizing tank, making it possible to extend the service life of the porous plates.

With the powder coating method according to the present embodiment, in a state where at least a part of the stator W gripped by the workpiece gripper 60 is immersed into the resin powder in the powder fluidizing tank 10, the insulating powder is applied while the workpiece gripper 60 is moved upward and downward by the workpiece conveyor 50. Therefore, since it is possible to allow the stator W immersed into the insulating powder in the powder fluidizing tank 10 to vibrate, and to move upward and downward the stator W immersed into the insulating powder, it is possible to allow the insulating powder to enter between the plurality of conductor segments W21 such as the coil ends W3 and to supply the insulating powder further inside the coil ends W3.

The embodiment of the present invention has been described above. However, the present invention is not limited to the embodiment described above. The embodiment described above may be modified appropriately within the scope of the present invention.

In the embodiment described above, in a state where at least a part of the stator W gripped by the workpiece gripper 60 is immersed into the resin powder in the powder fluidizing tank 10, the resin powder is applied while the workpiece gripper 60 is moved upward and downward by the workpiece conveyor 50. However, the resin powder may be applied without moving the workpiece gripper 60 upward and downward, and the resin powder may be applied by moving in the horizontal direction the workpiece gripper 60.

### EXPLANATION OF REFERENCE NUMERALS

1 POWDER COATING DEVICE
10 POWDER FLUIDIZING TANK
50 WORKPIECE CONVEYOR
60 WORKPIECE GRIPPER
W STATOR (WORKPIECE)

What is claimed is:

1. A powder coating device comprising:
a powder fluidizing tank configured to store resin powder;
a workpiece gripper configured to grip a workpiece; and
a workpiece conveyor configured to convey the workpiece gripper to immerse at least a part of the workpiece gripped by the workpiece gripper into the resin powder in the powder fluidizing tank,
the workpiece gripper including a vibrator configured to apply vibrations to the workpiece.

2. The powder coating device according to claim 1, wherein the workpiece conveyor is able to move the workpiece gripper upward and downward, in a state where at least the part of the workpiece gripped by the workpiece gripper is immersed into the resin powder in the powder fluidizing tank.

3. A powder coating method for applying a resin powder onto a workpiece by using a powder coating device including a powder fluidizing tank configured to store resin powder, a workpiece gripper configured to grip the workpiece, and a workpiece conveyor configured to convey the workpiece gripper, the powder coating method comprising,
in a state where at least a part of the workpiece gripped by the workpiece gripper is immersed into the resin powder in the powder fluidizing tank, applying the resin powder while vibrations are applied from the workpiece gripper to the workpiece.

4. The powder coating method according to claim 3, further comprising, in a state where at least the part of the workpiece gripped by the workpiece gripper is immersed into the resin powder in the powder fluidizing tank, applying the resin powder while the workpiece conveyor is moved upward and downward by the workpiece gripper.
